(19) United States
(12) Patent Application Publication
(10) Pub. No.: US 2019/0255713 A1
(43) Pub. Date: Aug. 22, 2019

(54) Robotic End-of-Arm Manual Tool Changer

(71) Applicant: Matthew Henry Churchill, Canton, CT (US)

(72) Inventor: Matthew Henry Churchill, Canton, CT (US)

(73) Assignee: Delkor Systems, Inc., St. Paul, MN (US)

(21) Appl. No.: 15/902,207

(22) Filed: Feb. 22, 2018

(51) Int. Cl. B25J 15/04

(52) U.S. Cl. CPC B25J 15/0408

(57) ABSTRACT

A manually actuated end-of-arm tool (EOAT) changer is described. EOAT changer includes an external housing within which an inner cam ring is fixed in place and a rotatable cam ring surrounds the inner cam ring. The inner cam ring defines ball bearing retaining cavities that extend from an exterior of the inner cam ring to an interior; a single ball bearing is at least partially contained in each cavity. The rotatable cam has interior surface which defines bearing engagement teeth. Each tooth is positioned adjacent to one of the ball bearings so as to engage the ball bearing and bias the ball bearing toward the interior of the inner cam ring when the rotatable cam ring is rotated from an open stat to a closed state. A swing arm is engaged to the rotatable cam ring. A yolk is engaged to the external housing and positioned adjacent to the swing arm. When the swing arm is engaged to the yolk the changer is in the closed position.

### FIELD OF THE INVENTION

The present disclosure is directed to end-of-arm tool (EOAT) changers and specifically to a type of manual EOAT changer that is utilized with tools equipped with a special quick change tooling adapter configured for use with the EOAT changer described herein. The combination of tool changer and adapter provides for a tool system comprising a variety of tools that may be used and easily inter-changed via the EOAT changer.

### SUMMARY

EOAT changers are devices that are used in robotic work cells which require multiple hardware configurations to fulfill an application set. The tool changing system is a separation point between a robot and its application specific tooling, typically consisting of one master device mounted to the robot and several tooling adaptors coupled to the tooling hardware.

There are many different mechanisms that may be used to couple the master and tooling adaptors but all of them consist of a clamping component and an alignment component. The clamping component must provide a rigid connection when coupled and freely release when uncoupled. The alignment component must ensure the correct orientation of the tool to the robot and provide rotary rigidity in cases when the clamping component does not.

Existing EOAT changers have a wide variety of operational characteristics, including profile limitations, center of mass requirements, tooling interface center point, weight and mass restrictions, payload limitations, their impact on robotic cycling applications, etc. These characteristics limit the various tool changers available to fairly specific applications with specific type of robotic arms or other masters. Upon review of the EOAT changers currently available, it was determined that a need existed for a low profile, manually operated, EOAT changer that is useable by a variety of robot master implements as well as a wide variety of tools. The EOAT changer and quick change tooling adapter described herein meets this need.

### BRIEF DESCRIPTION OF THE DRAWINGS

FIGS. 1-3 shows a sequence of perspective views wherein an EOAT is shown being decoupled from a robotic arm using an embodiment of the EOAT changer.

FIG. 4 is a perspective view of the quick change tooling adapter that an end-of arm tool is provided with to be used with the EOAT changer.

FIG. 5 is a perspective view of an embodiment of the EOAT changer shown adjacent to the quick change tooling adapter shown in FIG. 4.

FIG. 6a is an exploded component view of the EOAT changer shown in FIG. 5.

FIG. 6b is a detailed perspective view showing the relationship between the rotatable cam ring, fixed cam ring and the ball bearings of the EOAT changer shown in FIG. 6b with the quick change tool adapter shown in FIG. 4

FIG. 6c is the same illustration as FIG. 6b, but with the fixed cam ring removed, so as to more clearly depict the manner in which the ball bearings engage the pockets of the quick change adapter.

FIG. 7 is a perspective view of the EOAT changer shown in the open position and in contact with but not clamped to an EOAT.

FIG. 8 is a top down view of the EOAT changer and tool shown in FIG. 7.

FIG. 9 is an external side view of the EOAT changer and tool shown in FIGS. 7-8.

FIG. 10 is a side sectional view of the EOAT changer and tool shown in FIG. 9.

FIG. 11 is a cross-sectional view of a portion of the EOAT changer shown in FIG. 9.

FIG. 12 is a perspective view of the EOAT changer shown in the closed position and clamped to an EOAT.

FIG. 13 is a top down view of the EOAT changer and tool shown in FIG. 12.

FIG. 14 is an external side view of the EOAT changer and tool shown in FIGS. 12-13.

FIG. 15. is a side sectional view of the EOAT changer and tool shown in FIG. 14.

FIG. 16 is a cross-sectional view of a portion of the EOAT changer shown in FIGS. 14.

FIGS. 17-19 is a sequence of top down illustrations showing the manner in which the components of the EOAT changer interact when the EOAT changer is moved from the open (un-clamped) position to the closed (clamped position).

### DETAILED DESCRIPTION

As mentioned above the use of an EOAT changer provides for a system that allows a robotic arm or other implement to utilize a variety of different end-of-arm tools by providing the system with the ability to decouple, remove, align and recouple a new, and possibly different, tool to the arm in a quick manner with minimal downtime.

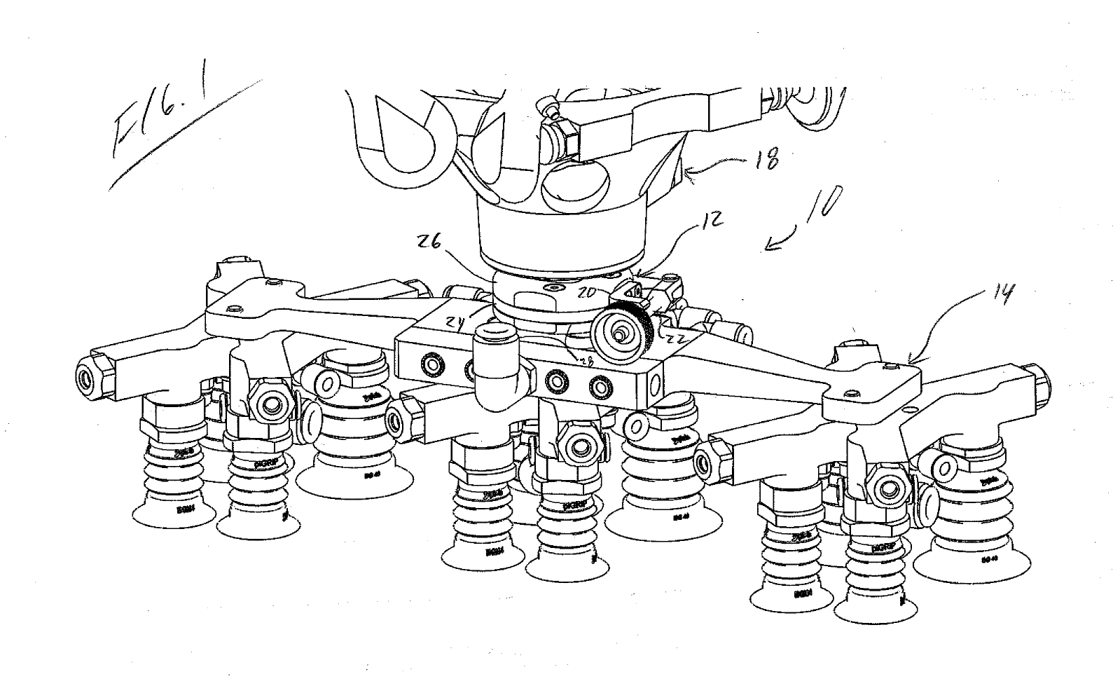

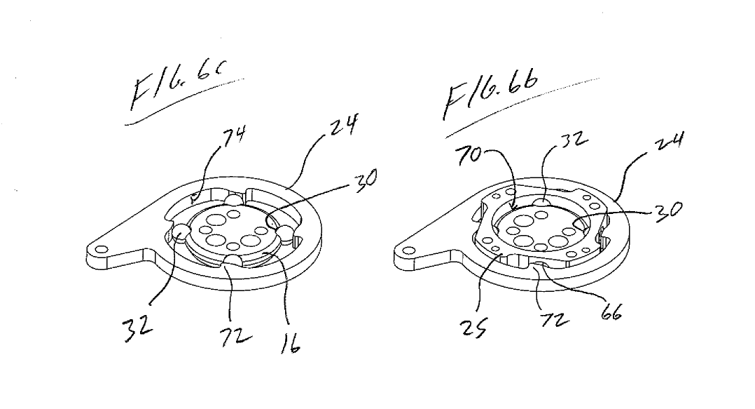

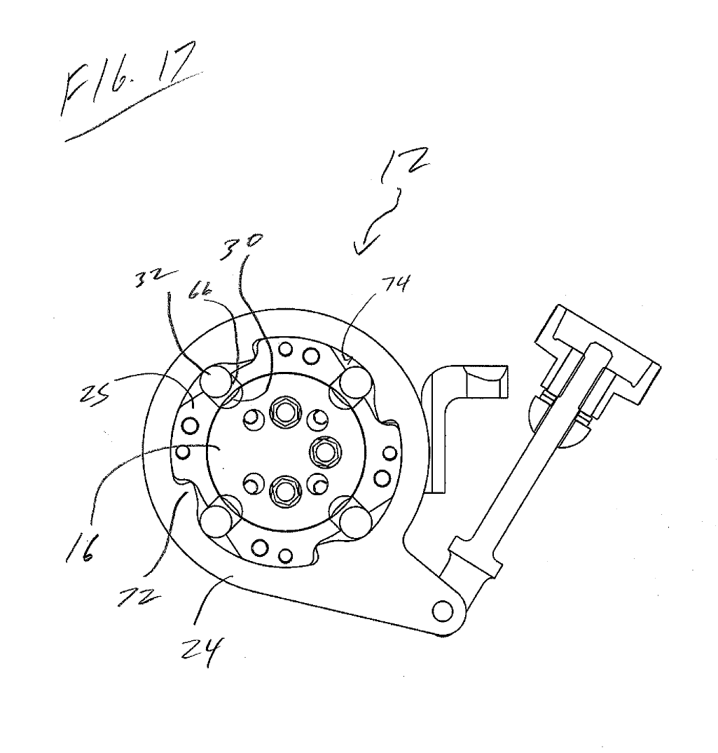

Embodiments of the present disclosure as shown in FIGS. 1-19, and described in detail below, provide for such system 10 having an EOAT changer 12 that mechanically communicates with any sort of tool 14 having a quick change tooling adapter 16 (visible in FIG. 3), configured to be aligned with and received by the EOAT changer 12 in the manner described in detail below.

As may be seen in FIGS. 1-3, the system 10 includes a robotic arm or other type of implement 18 to which a tool 14 is mechanically and operably engaged. The EOAT changer or coupler 12 is secured to the arm 18 and acts as an interface between the tool 14 and arm 18 by automatically aligning the tool 14 in a desired manner (via the interaction of the quick change tooling adapter 16 and the engagement surfaces 20 of the changer 12) and then mechanically grasping or clamping the tool 14 within the confines of the EOAT changer 12.

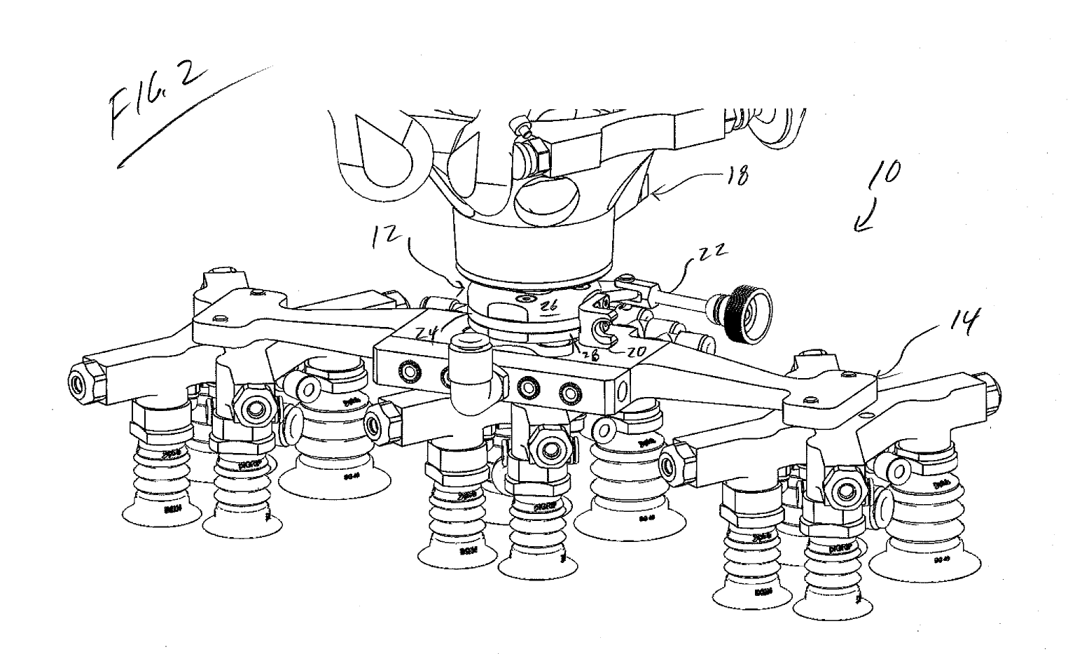

The EOAT changer 12 includes a clamping yolk 20 which engages a swing bolt 22 that acts to lock or actuate a rotatable cam ring 24 to lock the EOAT changer 12 to the tooling adapter 16 of the tool 14. By releasing the swing bolt 22 from the yolk 20 the cam ring 24 is actuated or rotated relative to the mounting plate 26 and retaining plate 28 to release the tooling adapter 16 from the EOAT changer 12 in the manner shown in FIGS. 2 and 3. The specific manner what the EOAT changer 12 and the tooling adapter 16 engage with one another is discussed in greater detail below.

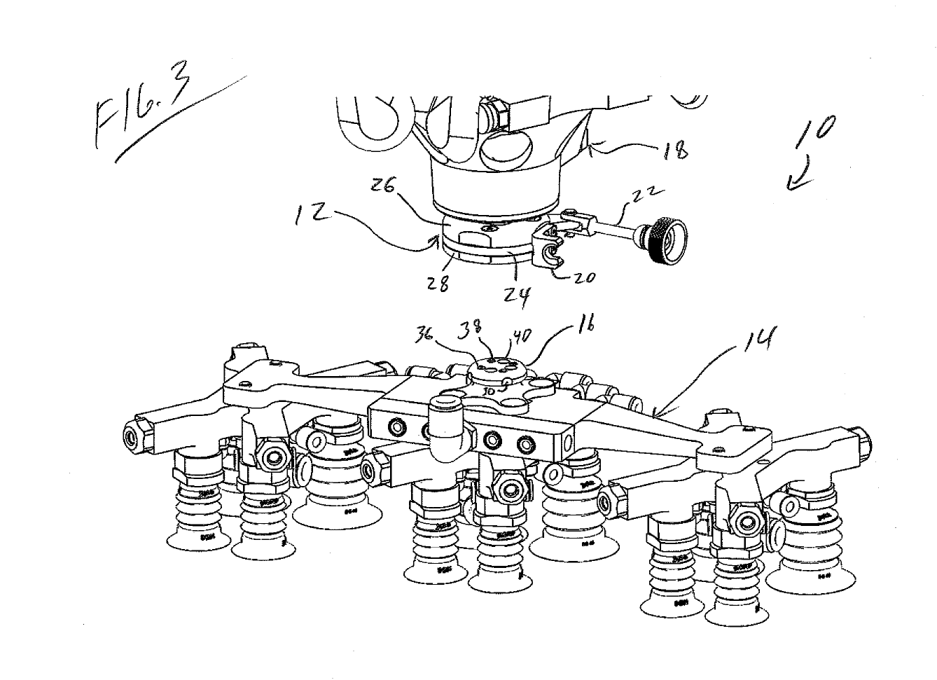

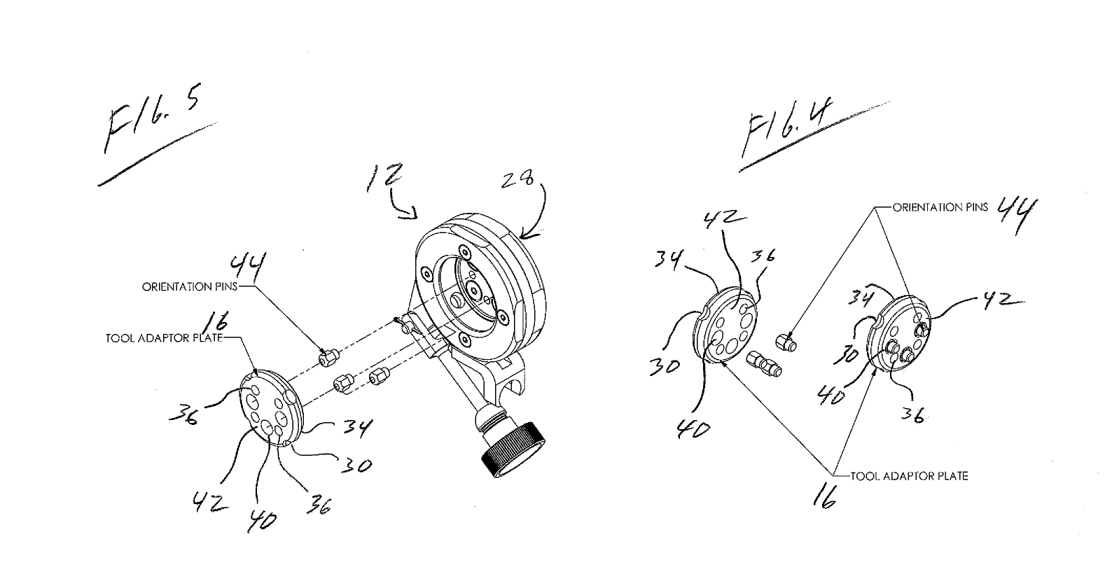

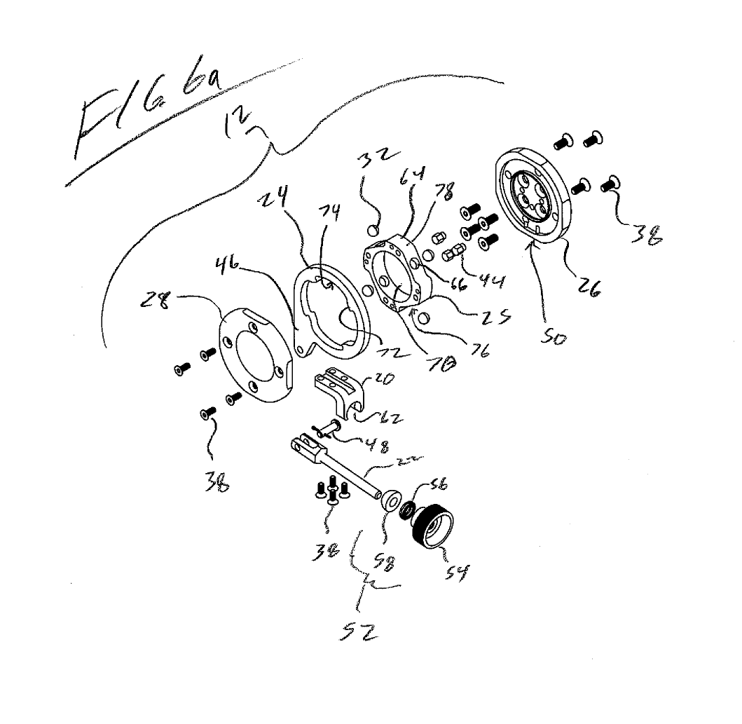

Turning now to the images shown in FIG. 4 the quick change tooling adapter 16 is illustrated showing the manner in which it engages alignment pins 44 that extend from the EOAT changer 12 shown in FIGS. 5 and 6. The adapter 16 is a disk shaped device defining a plurality of ball bearing receiving pockets 30, each of which are sized to match the size and shape of a ball bearing 32, which is illustrated in FIG. 6. The pockets 30 are essentially indentations cut into the outer perimeter 34 of the adapter 16 and may be machined with a close tolerance to match size of the ball bearings 32.

The pockets 30 may be of a shape that is cup-like in order to match the contour of the ball bearings, triangular so as to rigidly engage ball bearing tangentially along three points, shaped like a four-sided gothic arch to engage the bearing on four sides, etc. Regardless of the specific shape, it is a key aspect of the adapter 16 that the pockets 30 provide contact with a ball bearing 32 on at least two points so as to provide zero backlash in two degrees of freedom (axial and rotational).

In addition to the pockets 30, the tooling adapter 16 also defines at least three securement holes 36 for securing the adapter 16 to the tool 14, such as in the manner depicted in FIG. 3. The adapter 16 may be configured for attachment by bolts and nuts, screws, or other engagement mechanisms or fasteners 38 which pass into and/or through the holes 36 to secure the adapter 16 to the tool 14. In at least one embodiment the adapter 16 may define at least 4 securement holes.

Adjacent to the securement holes 36 are alignment holes 40 which are defined by the adapter 16. The presence of multiple alignment holes 40 on the engagement surface 42 of the adapter 16 provides a pattern of holes that are arranged to receive a corresponding pattern of alignment pins 44 that extend from the arm mounting plate 26 of the EOAT changer 12 in the manner illustrated in FIGS. 3-6a, 11, and 16-19. This corresponding pattern of holes 40 in the adapter 16 and pins 44 of the EOAT changer 12 are provided to ensure a fool-proof mechanism to ensure that the tool 14 (via the adapter 16) is always received onto the arm 18 (via the EOAT changer 12) with the proper orientation and alignment such as in the manner shown in FIGS. 1-3.

Turning now to FIG. 6a, the components that make up the EOAT changer 12, and their manner assembly to form the EOAT changer 12, are illustrated. The EOAT changer 12 is comprised of an external housing comprising the arm mounting plate 26 and the adapter retaining plate 28, with a rotatable cam ring 24 and fixed inner cam ring 25 positioned therebetween. Various fasteners 38 extend through the adapter retaining plate 28 to engage the fixed inner cam ring 25 from one side, and likewise from the opposite side, fasteners 38 extend through the arm mounting plate 26 to engage the fixed inner cam ring 25.

The rotatable cam ring 24 includes a flange or protrusion 46 to which the swing bolt 22 is pivotally engaged (such as by joining the swing bolt 22 to a hole in the protrusion 46 by clevis and cotter pin assembly 48 shown in FIGS. 5-6.). The yolk 22 is mounted (by fasteners 38) to a mounting surface 50 defined by a flattened area of the combined adapter retaining plate 28 and arm mounting plate 26 in the manner best shown in FIG. 5. The yolk 20 is configured to receive and retain the swing bolt 22 when the EOAT changer 12 is in the clamped or closed position shown in FIG. 1 and to release the swing bolt 22 when the EOAT changer 12 is in the open position shown in FIGS. 2 and 3.

In at least one embodiment the swing bolt 22 includes an end assembly 52 comprised of a thumb knob 54, a lock washer 56 and a spherical or hemi-spherical washer 58. The curved surface 60 of the spherical washer 58 is configured to engage a collar or channel 62, defined by the yolk 20, so as to bias the end assembly 52 of the swing arm 22 against the channel 62 and thereby retain the swing arm 22 in place within the yolk 20 when the EOAT changer 12 is in the clamped position. The thumb knob 54 provides an easily gripped surface that a user may manipulate when opening the EOAT changer 12 from the clamped position to the open position and vice versa. The lock washer 56 is configured to prevent the thumb knob 54 from loosening or being inadvertently removed from the spherical washer 58 and swing arm 22.

The act of moving the EOAT changer 12 from the open position to the closed or clamped position also cause the rotatable cam ring 24 to rotate within the confines of the sandwich like structure of the arm mounting plate 26 and adapter retaining plate 28. The rotatable cam ring 24 surrounds the fixed inner cam ring 25 to which the arm mounting plate 26 and adapter retaining plate 28 are engaged via fasteners 38. As the rotatable cam ring 24 rotates via the act of engaging the swing arm 22 to the yolk 20 or removing it therefrom, bearing engagement flanges 66 of the rotatable cam ring 24 move, relative to the outside surface 64 of the fixed inner cam ring 25.

The fixed inner cam ring 25 defines a plurality of bearing retaining cavities 66, within each of which a ball bearing 32 is moveably retained. The nature of this retention is a result of the cavity 66 being machined to allow at least partial passage of a ball bearing 32 through the cavity 66 sufficient to allow a portion of the ball bearing to extend into an interior 70 of the fixed inner cam ring 25. This arrangement allows the ball bearing 32 to contact and engage a receiving pocket 30 of an adapter 16 positioned within the interior space 70. The engagement occurs when the ball bearing 32 are biased through their respective cavities 66 and into a correspondingly positioned pocket 30 via contact with the teeth 72 of the rotatable cam ring 24, such as in the manner shown in FIG. 6b. In FIG. 6c the fixed inner cam ring 25 is illustrated removed from between the rotatable cam ring 24 and the adapter 16 to illustrate the manner in which the rotatable cam ring 24 biases the ball bearings 32 into contact and secured engagement with the pockets 30 of the adapter 16.

By this interface, the EOAT changer 12 engages or grasps a tool 14 that is equipped with a tooling adapter 16. The nature of this engagement and the interface between the adapter 16 and the EOAT changer 12 is depicted in the various illustrations of FIGS. 7-19.

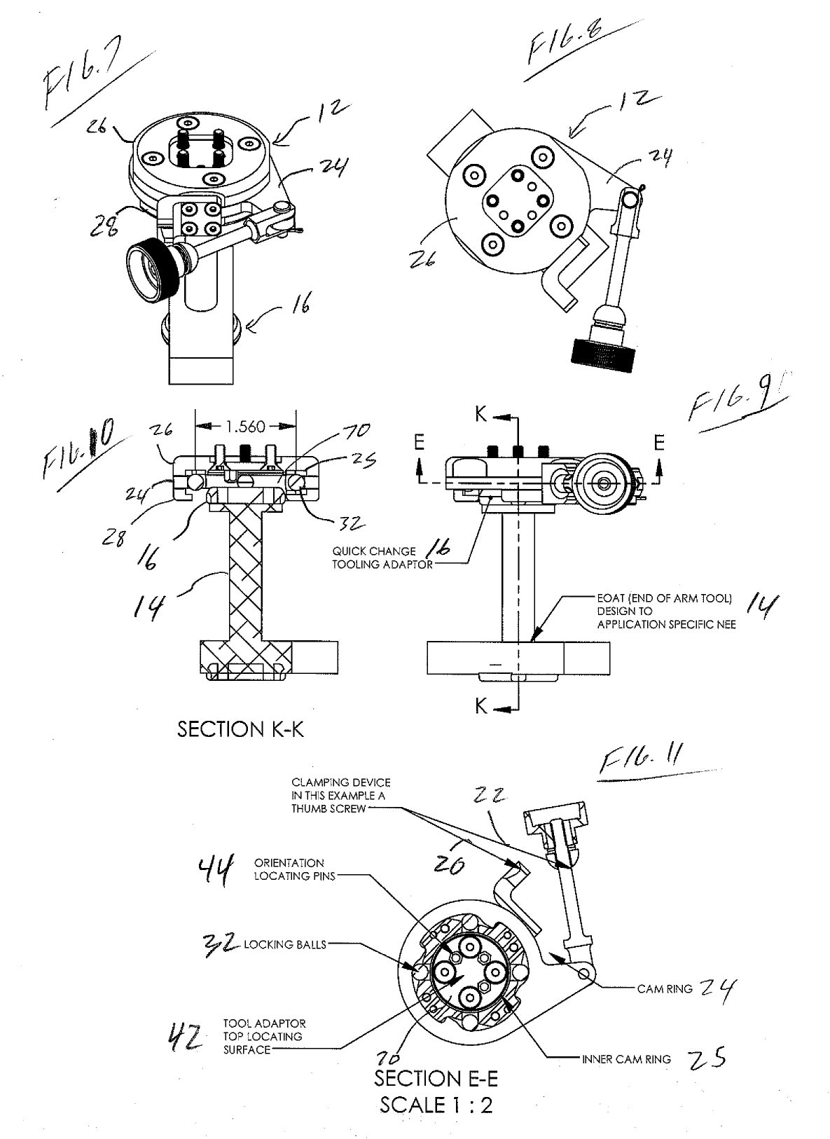

In. FIGS. 7-11 the EOAT changer 12 is shown in the open position prior to the securement of the tool adapter 16 within the confines of the EOAT changer 12, and specifically within the interior space 70 defined by the fixed inner cam ring 25 (see FIG. 10).

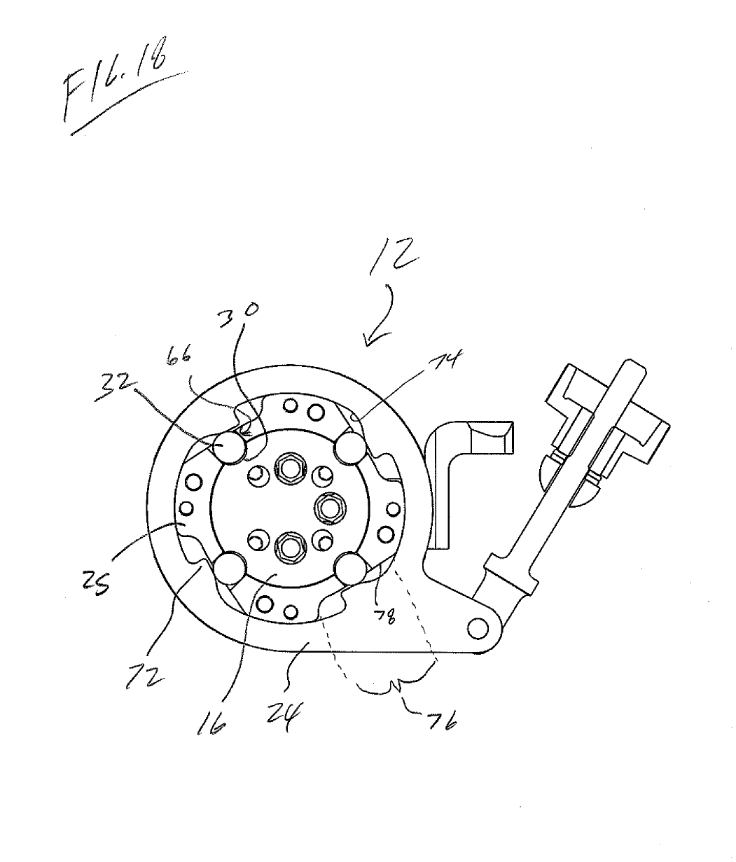

When the adapter 16 is properly positioned within the interior space 70, via pins 44, such as in the manner shown in FIG. 10, the ball bearings 32, held within the retaining cavities 66 of the fixed inner cam ring 25, align with the ball bearing receiving pockets 30 of the adapter 16 in the manner illustrated in FIG. 16.

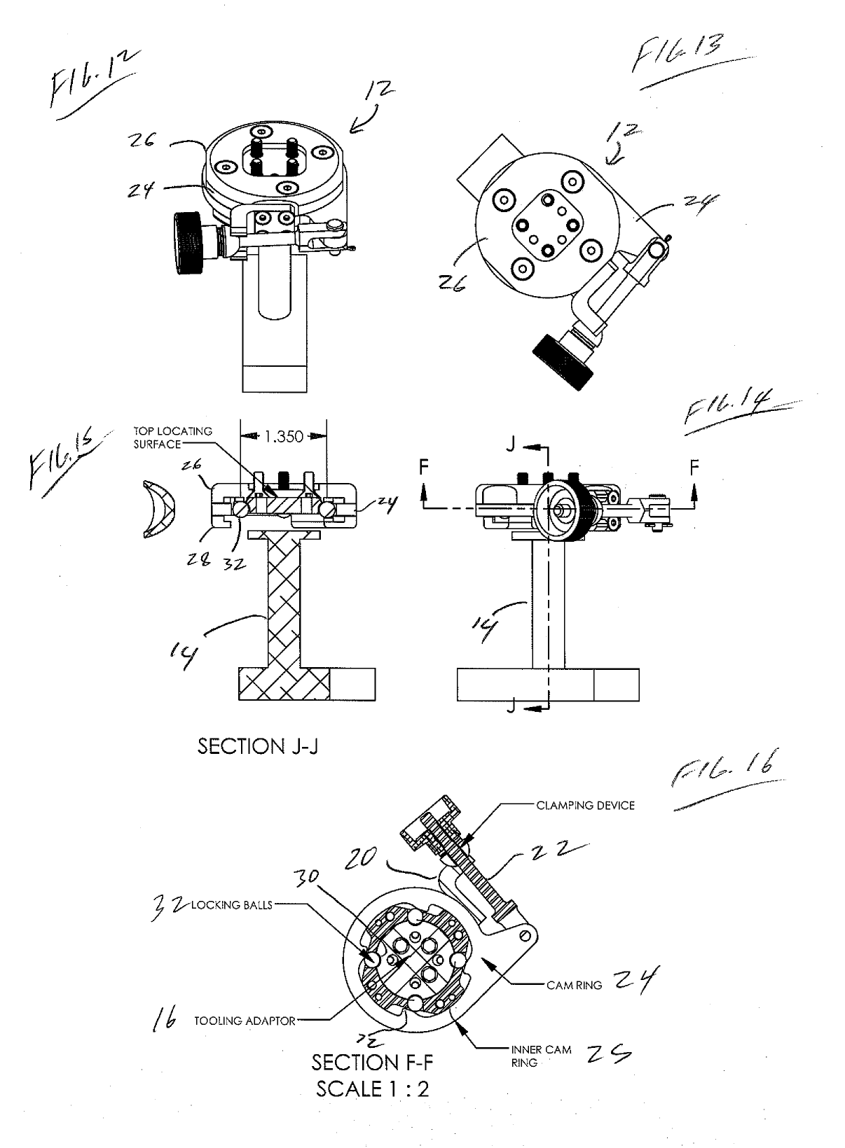

When the swing arm 22 is locked into the yolk 20 in the manner shown in FIGS. 12-16, the rotatable cam ring 24 is rotated in the manner illustrated by comparing FIGS. 11 and 16. This act of rotation pushes the bearings 32 into the pockets 30 of the adapter 16, thereby locking the adapter 16 in place within the interior 70 of the fixed inner cam ring 25 in the manner shown in FIG. 16 and in the sequence depicted in FIGS. 17-19.

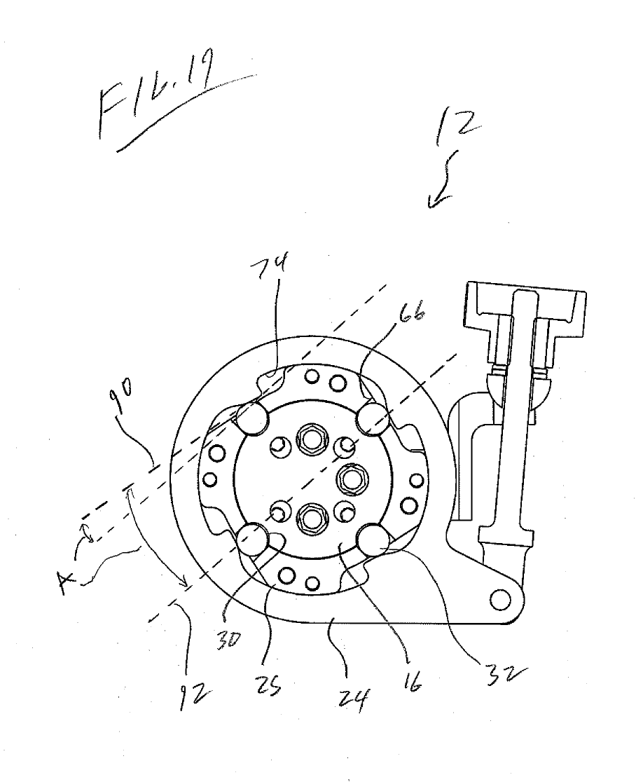

The act of locking the bearings 32 into the adapter pockets 30 is made possible by the presence of radially displaced bearing engagement teeth 72 positioned on the interior surface 74 of the rotatable cam ring 24, and which are positioned within corresponding radially positioned grooves 76 provided by the exterior surface 78 of the fixed inner cam ring 25, in the manner depicted in FIG. 18. The length and shape of each grove 76 relative to the interior extending height of each tooth 72, limit the extent of the radial travel of the rotatable cam ring 24 relative to the fixed inner cam ring 25.

As the rotatable cam ring 24 moves radially relative to the fixed inner cam ring 25 the inwardly extending teeth 72 are drawn over and against the bearings 32. When the EOAT changer 12 is in the fully clamped or closed position such as is shown in FIGS. 12-16 and 19 each tooth 72 biases a bearing 32 such that the bearing 32 is pushed at least partially through its retaining cavity 66 defined by the fixed inner cam ring 25 and into the interior 70. If the adapter 16 is present within the interior 70 then the bearings 32 are pushed into and engage the bearing receiving pockets 30. In at least one embodiment the final angle of the cam surface is 5 degrees from the line 90 corresponding to where the ball bearings 32 contact both the pocket and the cam relative to a centerline 92. This 5 degree angle of the cam surface is illustrated in FIG. 19 with the angle depicted by the double arrowed lines labeled A.

When the bearings 32 are engaged by the teeth 72 and each bearing 32 is thusly forced into one of the pockets 30 of the adapter 16, such as in the manner shown in FIG. 19, the EOAT changer 12 is in the fully clamped or closed position; whereby the tool 14 is secured to the changer 12 until the swing arm 22 is removed from the yolk 22 and the process is reversed.

The EOAT changer as shown in FIGS. 1-19 and described above provides for a very compact and robust coupling with zero backlash. Tooling alignment is assured upon assembly by the uneven pattern of loose fitting alignment pins 44 through the tooling adaptor 16. When the rotatable cam 24 is rotated into the closed position and bearings 32 engage the spherical pockets 30 in the tooling adaptor 16, the tool 14 is locked into its final position with less than 0.25 mm of positional and less than 0.25 degrees of rotary repeatability. Clamping force is retained by a 5 mm threaded swing bolt 22 seated into a yolk 20 adjacent thereto. This swing bolt 22 is protected from vibration in the coupling by the mechanical advantage of the system and includes a wedge locking washer 56 to ensure torque retention.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A manually actuated end-of-arm tool (EOAT) changer having an open state and a closed state, the EOAT changer comprising:
an external housing, the external housing containing an inner cam ring fixed in place relative to the external housing and a rotatable cam ring surrounding the inner cam ring,
the inner cam ring defining a plurality of ball bearing retaining cavities, each cavity extending from an exterior of the inner cam ring to an interior of the inner cam ring and having a single ball bearing at least partially contained therein,
the rotatable cam ring having an interior surface defining a plurality of bearing engagement teeth, each tooth positioned adjacent to one of the ball bearings, from the open state to the closed state rotation of the rotatable cam ring relative to the inner cam engages one of the plurality of the bearing engagement teeth with one of the ball bearings and biases the ball bearing toward the interior of the inner cam ring;
a swing arm engaged to the rotatable cam ring;
a yolk engaged to the external housing and positioned adjacent to the swing arm, the yolk defining a channel into which at least a portion of the swing arm is removeably received, in the closed state the at least a portion of the swing arm being positioned within the channel and engaged by the yolk.

2. The EOAT changer of claim 1 wherein the external housing comprises an arm mounting plate and an adapter retaining plate; a first plurality of fasteners extend through the adapter retaining plate and engage the fixed inner cam ring, a second plurality of fasteners extend through the arm mounting plate to engage the fixed inner cam ring.

3. The EOAT changer of claim 2 wherein the arm mounting plate is engaged to the end of a robotic arm.

4. The EOAT changer of claim 3 further comprising a plurality of alignment pins, the plurality of alignment pins being engaged to and extending from the arm mounting plate and into the interior of the inner cam ring.

5. The EOAT changer of claim 4 further comprising a quick change tooling adapter, the quick change tooling adapter sized to fit within the interior of the inner cam ring.

6. The EOAT changer of claim 5 wherein the quick change tooling adapter defines a plurality of alignment holes extending therethrough, each of the plurality of alignment pins being positioned to substantially align with and be received within one of the plurality of alignment holes when the quick change tooling adapter is positioned within the interior of the inner cam ring.

7. The EOAT changer of claim 6 wherein the quick change tooling adapter comprises a perimeter, the perimeter defining at least four ball bearing receiving pockets, when the EOAT changer is in the closed position each of the ball bearings is biased against one of the ball bearing receiving pockets thereby securing the quick change tooling adapter within the interior of the inner cam ring.

8. The EOAT changer of claim 1 wherein the rotatable cam ring defines a center line and a cam engagement surface line defined by the surface where each tooth of the rotatable cam ring engages each of the ball bearings in the closed position; the center line and the cam engagement surface line defining an angle of 5 degrees.

9. A system for switching tools comprising:
an EOAT changer, the EOAT changer having:
an external housing, the external housing containing an inner cam ring fixed in place relative to the external housing and a rotatable cam ring surrounding the inner cam ring,
the inner cam ring defining a plurality of ball bearing retaining cavities, each cavity extending from an exterior of the inner cam ring to an interior of the inner cam ring and having a single ball bearing at least partially contained therein,
the rotatable cam having an interior surface defining a plurality of bearing engagement teeth, each tooth positioned adjacent to one of the ball bearings and being rotatably movable relative thereto when the rotatable cam is rotated between an open position and a closed position, in the closed position each tooth engages one of the ball bearings and biases the ball bearing toward the interior of the inner cam ring,
a swing arm engaged to the rotatable cam ring;
a yolk engaged to the external housing and positioned adjacent to the swing arm, the yolk defining a channel into which at least a portion of the swing arm is removeably received, in the closed state the at least a portion of the swing arm being positioned within the channel and engaged by the yolk; and
a quick change tooling adapter, the quick change tooling adapter being engaged to a surface a tool, the quick change tooling adapter sized to fit within the interior of the inner cam ring, the quick change tooling adapter having a perimeter, the perimeter defining a plurality of ball bearing receiving pockets;
when the EOAT changer is in the closed position each of the ball bearings is biased against one of the ball bearing receiving pockets thereby securing the quick change tooling adapter within the interior of the inner cam ring.

10. The system of claim 9 wherein the tool is a plurality of tools wherein each tool is equipped with a quick change tooling adapter.
